(19) United States
(12) Patent Application Publication
(10) Pub. No.: US 2023/0009778 A1
(43) Pub. Date: Jan. 12, 2023

(54) Shapeable Stringed Instrument Saddle containing a Plurality of Electrically Independent Transducers

(71) Applicants: Benjamin Wade Shaw, Nashville, TN (US); Paul Daniel McGill, Nashville, TN (US)

(72) Inventors: Benjamin Wade Shaw, Nashville, TN (US); Paul Daniel McGill, Nashville, TN (US)

(73) Assignee: Go Acoustic Audio, LLC, NASHVILLE, TN (US)

(21) Appl. No.: 17/811,580

(22) Filed: Jul. 9, 2022

Related U.S. Application Data
(60) Provisional application No. 63/220,185, filed on Jul. 9, 2021.

(51) Int. Cl. G10H 3/18; G10D 3/12; G10D 3/22; G10H 3/14

(52) U.S. Cl. CPC G10H 3/185; G10D 3/12; G10D 3/22; G10H 3/181; G10H 3/143; G10H 2220/525

(57) ABSTRACT

A stringed musical instrument saddle containing a plurality of electrically independent transducers and associated electrical conditioning components where each transducer is located within the saddle such that it is sensitive to the vibratory energy of a corresponding string or course and senses the vibratory energy in both vertical and horizontal modes. The saddle contains at least one multi-conductor connector which connects to a removable multi-conductor cable to convey the transducer signals out of the saddle to external receiving electronics. The saddle is constructed of workable materials such that its top and bottom can be fit to a particular instrument by a technician.

### CROSS-REFERENCE TO RELATED APPLICATIONS

This application claims the benefit of U.S. Provisional Application Ser. No. 63/220,185 titled “Novel Acoustic Instrument Pickup Contained Within the Instrument Saddle and Accompanying Electronic Preamp,” filed by Benjamin Shaw and Paul McGill on Jul. 9, 2021.

### STATEMENT REGARDING FEDERALLY SPONSORED RESEARCH OR DEVELOPMENT (IF APPLICABLE)

Not Applicable

### BACKGROUND OF INVENTION

### 1. Field of Invention

The present invention relates generally to stringed musical instruments, and more specifically, to instrument saddles with internally integrated transducers which provide separate electrical outputs for each transducer.

### 2. Background Invention and Description of Related Art

The need for the invention is caused by the struggles of musicians to control and shape the natural acoustic properties of the instrument. Amplification of acoustic instruments often results in the undesirable effect of feedback, where the output of the instrument's amplifier is picked up by the instrument transducer and re-amplified. This results in a high-volume screeching sound. Feedback can be mitigated by filtering the frequency content of the instrument signal to remove frequencies prone to feedback. However, this alters the sound of the instrument making it sound less like it does acoustically. The invention provides the capability to prevent feedback without the need for frequency filtering which alters the amplified sound of the instrument.

Other methods of mitigating feedback sensitivity and reproducing the acoustic sound of the instrument require a plurality of transducers located separately within the structure of the instrument. This complexity has the drawback of being difficult to install and maintain. Additionally, some of these methods negatively affect the acoustic sound of the instrument by limiting the transfer of each string's vibrational energy to the instrument soundboard. The invention solves the problem of complexity by locating the transducers within a single physical structure which comprises the instrument saddle and that contains removable electrical cables for the transducer output signals. This allows for simple installation and maintenance of the pickup. The invention does not have the problem of string energy transfer to the instrument bridge because it is designed to allow energy transfer in the same manner as an instrument with a traditional solid saddle.

Various attempts have been made at solving the problem of natural sound without feedback sensitivity. For example, the U.S. Pat. No. 5,206,449 to McClish discloses dual transducers designed to capture the multidirectional energy of each string which are then separately processed before being summed. While this design may overcome the feedback sensitivity problem and sound natural, it is very complex, requiring multiple transducers and associated processing circuitry, and is therefore expensive.

In another example, U.S. Pat. No. 5,218,159 to McClish discloses a vertical application of pressure to drive a piezoelectric bender. The design uses a suspended string rest having greater central mass to produce a sine wave transmission outward from center. The greater central mass results in a low mass at each end of the string rest where it connects to the base. These connection points are susceptible to failure from lateral forces experienced by the pickup during normal use of the instrument.

The design intends to mechanically isolate the vibrating string from the vibrating instrument soundboard. However, there are two problems with this. First, vibrational energy from the soundboard travels back up the string from its attachment point on the bridge bypassing the mechanical isolation designed into the pickup. Second, because of the mechanical isolation designed into the pickup, the vibrational energy of the string is isolated from the soundboard of the instrument, negatively affecting the acoustic tonality of the instrument.

This design requires an individual saddle with transducer per string or course on the instrument. This requires separate holes in the saddle slot of the bridge for the electrical wires from each pickup to pass into the interior cavity of the instrument to connect to the preamp. This complexity is not widely accepted in the industry because of the work required to install such a pickup system, the perceived harm to the structural integrity of the instrument bridge by the multiple holes through which the cables must pass, and the non-traditional look of individual saddles in the instrument bridge.

U.S. Pat. No. 11,348,563 B2 to Lloyd Baggs Innovations, LLC discloses an improvement on U.S. Pat. No. 5,218,159 to McClish to correct the structural issues of the design. The McClish design features pressed tabs to secure the bender, or string rest, at each end. This weak integration is designed to enhance maximum amplitude of the bender hinged at each end by this pressed fit. However, it is susceptible to mechanical failure as lateral forces experienced in the normal use of the instrument bend the pressed tabs causing the bender, or string rest, to break off from the base. These improvements do solve the structural issues in the McClish design, but at the cost of the motion of the saddle to which the transducer is connected. Like the McClish design, in this design, the transducer only senses string energy in the vertical direction.

This design is designed to be a replacement for the RMC pickup and therefore uses individual saddles for each string or course. It is therefore subject to the same industry acceptance problems as the RMC. The McClish and Baggs designs were and are used by Godin Guitars of Canada. These designs have not been universally accepted aftermarket products for the above-mentioned reasons, irrespective of product capabilities or positive attributes.

An alternative approach is disclosed in the U.S. Pat. No US 2013/0160634 A1 to Taylor Guitars which requires specialized installation of an external transducer contacting the saddle through the side wall of the bridge slot which contains the saddle. In this design the transducer works only in the horizontal direction, picking up the motion of the saddle as it rocks back and forth in the bridge slot.

Because the transducers contact the side of the saddle, significant modifications must be made to the instrument bridge to allow for the location of the transducers. This is not a problem if these modifications are done as part of the instrument manufacturing process, but they are too complicated to be made after the instrument has been built. This limits the implementation of the design to newly manufactured instruments.

Yet another approach is disclosed in the U.S. Pat. No. 7,943,838 B2 to Dunwoodie which features a single piece saddle with an internal cavity open to the bottom of the saddle. A transducer is inserted and secured into this cavity so that the bottom of the transducer is recessed from the open end of the cavity. This mounting method prevents the transducer from being vertically compressed between the top edge of the cavity and the bottom of the bridge slot, which would result in an inferior tonal quality.

The location and mounting of the transducer to the saddle is critical to energy transfer from the saddle to the transducer. If the transducer is not consistently mounted, then each transducer will have a significantly different response characteristic. Consistent mounting is made difficult in this design by the requirement to mount the transducer inside a cavity with adhesive, which is hard to control. Graph Tech's commercial implementation of this design suffers from inconsistent mechanical coupling of the transducer to the saddle. Their commercial implementation also uses individual saddles and transducers for each string or course. Therefore, a time-consuming pickup matching process is required to ensure that each pickup used on an instrument will have sufficiently similar output characteristics. This problem is in addition to the above-described problems with individual saddles and transducers for each string or course.

U.S. Pat. No. 8,507,783 B1 to Barbera discloses the only design reviewed which has been commercially implemented where the transducers for each string or course are contained within a single physical structure. U.S. Pat. No. 7,943,838 B2 to Dunwoodie includes this arrangement, but Graph Tech has not made a commercial product using it. The Barbera design electrically combines all of the transducers into a single output signal rather than leaving each transducer electrically separate as do McClish, Baggs, and Graph Tech.

This design has the benefit of simplicity which the other designs reviewed do not. However, this design has limited mechanical isolation between transducers and only senses vibrations along the vertical axis. The result is that it does not mitigate the risk of feedback as well as the other designs which depend on electrical processing of the individual transducer signals to prevent feedback.

There remains a need for an instrument pickup which combines the simplicity of a single saddle structure as disclosed in the U.S. Pat. No. 8,507,783 B1 to Barbera, but which maintains individual transducer outputs which allows for the best possible feedback mitigation as seen in the U.S. Pat. No. 5,218,159 to McClish, U.S. Pat. No. 11,348,563 B2 to Lloyd Baggs Innovations, LLC. Additionally, the pickup design should not mechanically isolate the string from the bridge as seen in U.S. Pat. No. 5,206,449 to McClish, U.S. Pat. No. 5,218,159 to McClish, U.S. Pat. No. 11,348,563 B2 to Lloyd Baggs Innovations, LLC, and U.S. Pat. No. 8,507,783 B1 to Barbera because this isolation is detrimental to the acoustic sound of the instrument.

### BRIEF SUMMARY OF INVENTION

The present invention comprises a novel stringed instrument pickup generally consisting of a plurality of piezoelectric transducers mounted in the cavities created by a laminate structure of two or more layers of solid material such as fiberglass or aluminum. The laminate structure will be capped with a string rest so that the entire device comprises an instrument saddle. One or more layers of the laminate may contain one or more layers of copper etched to comprise a single or greater layer circuit board. The individual transducer signals will be conveyed through the laminate structure on one or more layers of one or more laminate pieces to reach a connector. The invention will contain one or more connectors for removable cables which will convey the transducer signals to the preamp. The string rest as well as the bottom of the saddle will have the ability to be shaped by an instrument technician such that the instrument will maintain optimum playability.

The transducers are rigidly mounted to the inside of each cavity on 2 faces, the sidewall of the cavity and the bottom of the string rest such that string vibrational energy is then received in two perpendicular directions, lateral and vertical. Because the transducer senses string vibrational energy in these two directions, it is less sensitive to the distance between the top of the transducer and the top of the string rest. In designs which pickup string vibrational energy in only the downward direction from the string, the transducer output level will be inversely proportional to the distance from the string. Two directional sensitivity reduces the output variation caused by string height over the bridge, radius required to match fretboard radius, and staggering of string length over the width of the string rest to provide proper string intonation. Consequently, the invention acts as a traditional instrument saddle while maintaining sufficiently similar output characteristics between all transducers within it.

### BRIEF DESCRIPTION OF THE SEVERAL VIEW OF THE DRAWING

FIG. 1 depicts an isometric view of a typical stringed acoustic instrument, in this case a guitar.

FIG. 2 depicts an isometric view of an instrument saddle and its signal cables according to an exemplary embodiment of the present invention.

FIG. 3 depicts a sectional view from the side of an exemplary embodiment of the present invention which illustrates the embodiment's internal features.

FIG. 4 depicts a rear view of a laminate structure along with its minor components of an exemplary embodiment of the present invention.

FIG. 5 depicts a rear isometric view of multiple connected laminate structures of an exemplary embodiment of the present invention. This view depicts the internal transducers and the cavities in which they are located along with other internal mechanical features.

FIG. 6 depicts a rear isometric of an exemplary embodiment of the present invention and depicts the features on the back side of the exemplary embodiment.

FIG. 7 depicts a sectional view from the side of an exemplary embodiment of the present invention which illustrates the embodiment's internal features and the external forces imposed on the invention by an instrument string.

FIG. 8 depicts a front isometric view of a laminate structure of an exemplary embodiment of the present invention and depicts the embodiment's internal electrical features.

FIG. 9 depicts a front isometric view of multiple connected laminate structures of an exemplary embodiment of the present invention which depicts the internal mechanical and electrical features of the embodiment.

FIG. 10 depicts a rear isometric view of the complete laminate structure of an exemplary embodiment of the present invention that shows the internal mechanical and electrical contacts between internal components of the embodiment.

FIG. 11 depicts a front isometric view of an alternate embodiment of the device which combines a laminate structure and the string rest into a single component.

FIG. 12 depicts an isometric view of a musical instrument preamp which receives the electrical signals from the present invention through the depicted multi-conductor cables.

Like reference symbols in the various drawings indicate like elements.

### DETAILED DESCRIPTION OF THE INVENTION

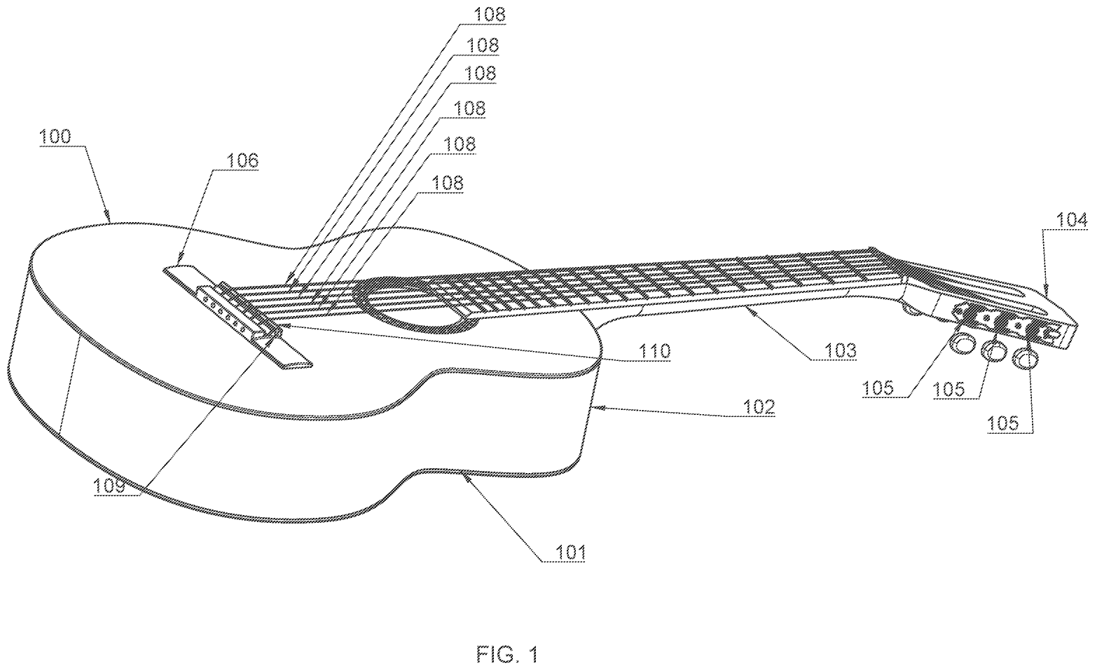

Referring to FIG. 1, a typical acoustic stringed instrument consists of a hollow body formed by a front face 100, called a soundboard, a back 101, and sides 102. This three-piece structure comprises the body of the instrument. A neck 103 extends longitudinally from the body. At the distal end of the neck from the body is a headstock 104 which contains a plurality of tuners 105 which receive and tighten a plurality of strings 108. Mounted on the soundboard 100 is a bridge 106 which receives the other end of the strings 108. The bridge contains a bridge slot 109 which receives a saddle 110. As the strings vibrate, the vibrational energy is transferred through the saddle 110 into the bridge 106 and soundboard 100 which vibrates and produces sound. The present invention will be referred to as a saddle 110 in order clarify its location and function within the instrument.

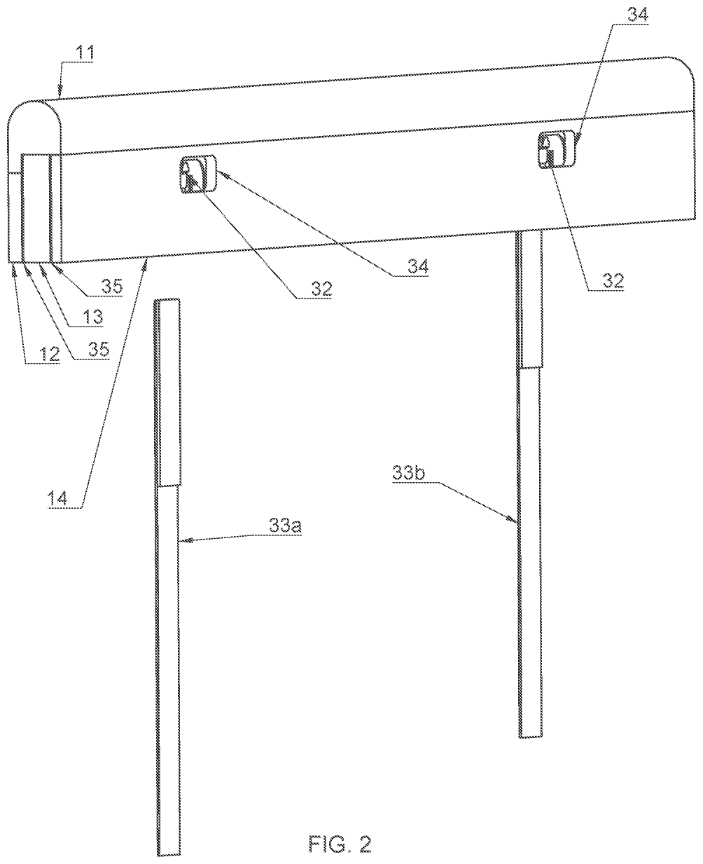

Referring now to FIG. 2 which shows an isometric view of a preferred embodiment of the present invention. In this preferred embodiment, an instrument saddle 110 is composed of a plurality of laminated structures consisting of a back laminate 12, an inner laminate 13, and a front laminate 14, where the front laminate 14 faces the neck 103 (see FIG. 1) of the instrument. One or more of these laminate structures 12, 13, and 14 contains electrical traces so that it comprises a circuit board. This laminate structure is capped with a string rest 11 and in total comprises an instrument saddle 110 (see FIG. 1).

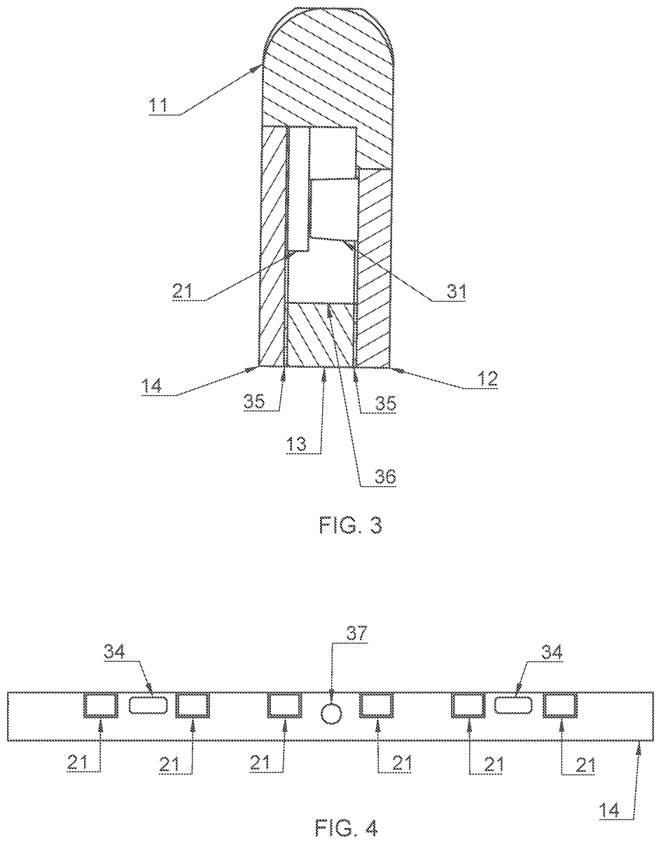

Each laminate layer 12, 13, and 14 is adhered to any abutting laminate layer 12, 13, and 14 by an adhesive layer 35 such as glue, epoxy, adhesive film, or solder. This adhesive layer 35 may be more easily seen in FIG. 3. Likewise, the string rest 11 is adhered to the laminate structure using a layer of adhesive such as glue, epoxy, adhesive film, or solder. This layer may exist anywhere the string rest 11 abuts the laminate structure.

Internal to this saddle 110 are a plurality of piezoelectric transducers 21 (shown in FIGS. 3, 4, 5, and 10). Their output signals are conducted out of the saddle 110 via connectors 32 which receive removable cables 33. FIG. 2 depicts removable cable 33a removed from the saddle 110 and removable cable 33b inserted into one of the connectors 32 of the saddle 110. One skilled in the art will recognize that the number of connectors 32 utilized may vary with the number and locations of the transducers 21 contained within the saddle 110 as well as the number of electrical conductors present in the connector 32. There may be as few as one connector 32 or a plurality. Each connector 32 is accessible to a technician via an opening 34 which allows access to the connector 32. In this preferred embodiment, the openings 34 are located in the front laminate 14. However, they may be located in other locations of the saddle 110 depending on the access requirements of the connectors 32.

The string rest 11 is able to be shaped by a technician. This shaping may be required to set the total height of the saddle 110, to create a radius which matches the radius of the neck 103, or to properly intonate the strings 108. The bottom of the saddle 110 may also be sanded in order to reduce the total height of the saddle 110.

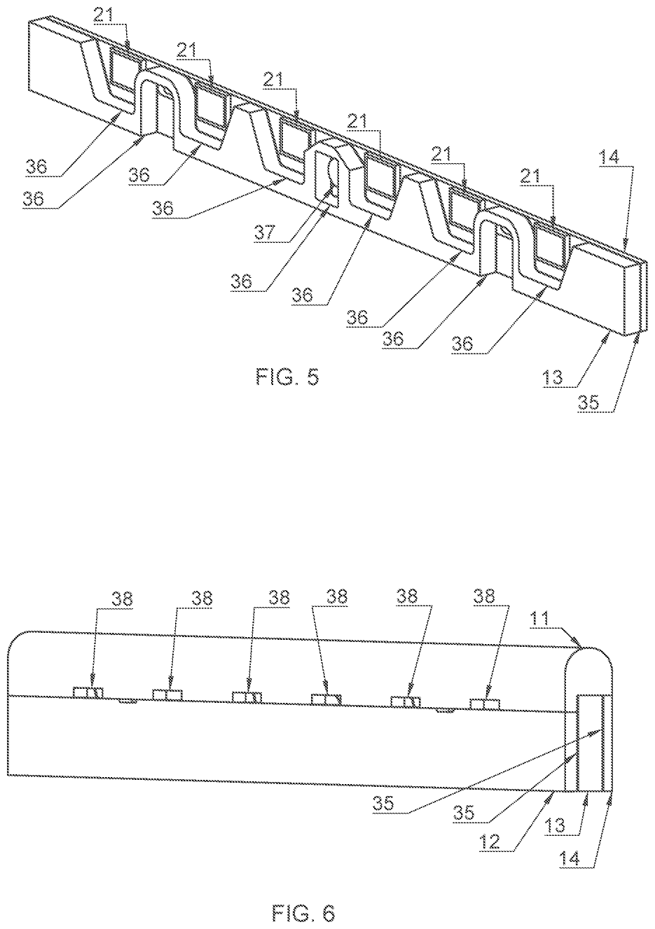

FIG. 3 depicts a section view of the saddle 110 and shows one of the plurality of piezo transducers 21. The inner laminate 13 is designed in such a way to create a plurality of cavities 36 inside the laminate structure (see also FIG. 5). These cavities 36 allow space for the piezo transducers 21 and associated components (to be described below). The transducer 21 is rigidly mounted to the front laminate 14 with an electrically conductive adhesive such as solder or electrically conductive epoxy. This electrically connects one electrode of the transducer 21 to an electrical trace contained within the front laminate 14. The second electrode of the transducer 21 is connected to the back laminate 12 via a flexible electrical conductor 31 such as a metal spring or electrically conductive foam. This flexible electrical conductor 31 is rigidly mounted to the back laminate 12 and only frictionally connected to the transducer 21. This flexible electrical conductor 31 is connected to an electrical trace contained within the back laminate 12. The transducer is also rigidly connected to the string rest 11 with an adhesive such as glue, epoxy, adhesive film, or solder. In this way, the transducer 21 is rigidly mounted to the saddle 110 on only 2 faces and frictionally connected to the flexible electrical conductor 31.

FIG. 4 depicts a back view of the preferred embodiment of the front laminate 14 along with its rigidly and electrically mounted components such as the piezo transducers 21 and electrical contact point 37. The plurality of transducers 21 are spaced along the length of the front laminate 14 so that they are located directly under the string 108 (see FIG. 1) whose vibrations they are sensing. In the preferred embodiment, the electrodes of the plurality of transducers 21 which are rigidly and electrically connected to the front laminate 14 are electrically connected together. This electrical signal is accessed at an electrical contact point 37. This contact point 37 is electrically connected to the back laminate 12 via a flexible electrical conductor 33 (shown in FIGS. 8, 9, and 11). In this way, all electrical signals reach the connectors 32 mounted on the back laminate 12 (see FIG. 8). One skilled in the art will recognize that at least one electrical contact point 37 is required to electrically connect the front laminate 14 to the back laminate 12, but a plurality may be utilized depending on the number of electrical signals to be conducted between the laminates.

FIG. 5 is a rear isometric view of the preferred embodiment of the invention and depicts the front laminate 14, its rigidly and electrically mounted components 21 and 37, the center laminate 13 shaped to form cavities 36 which allow space for the transducers 21 and flexible electrical conductors 31 and 33. The adhesive layer 35 exists everywhere the center laminate 13 abuts the front laminate 14.

FIG. 6 depicts a rear isometric view of the preferred embodiment of the invention. The string rest 11 contains a plurality of notches 38 which are aligned with the cavities 36 which contain the transducers 21. These notches prevent the string rest from contacting the top of the back laminate 12 in alignment with the cavities 36.

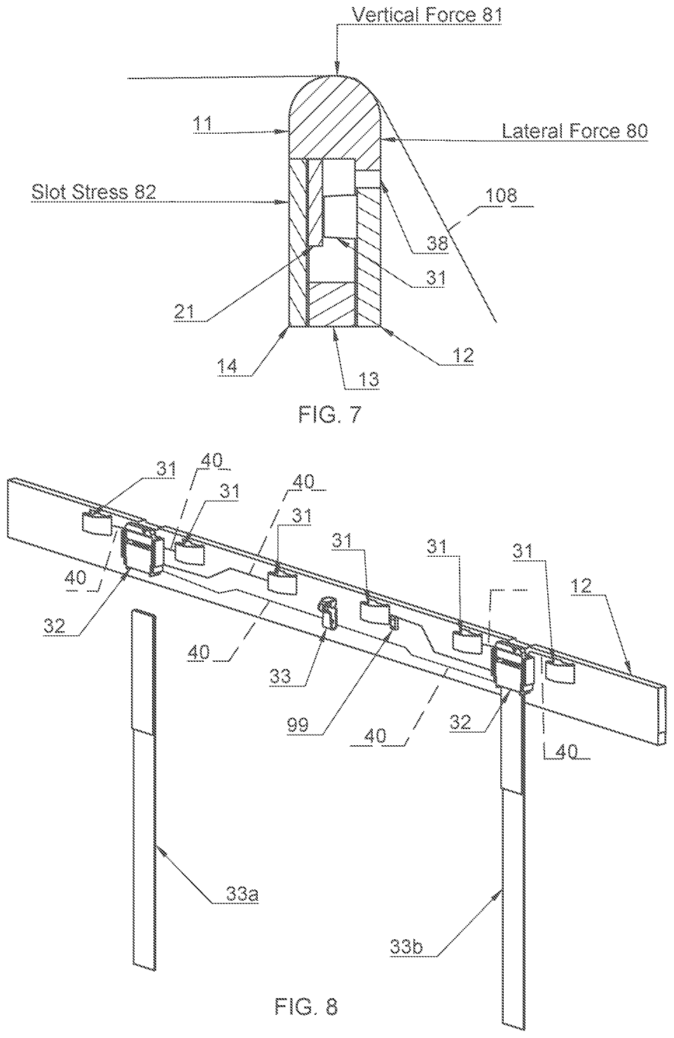

Referring now to FIG. 7, as a string 108 vibrates it periodically increases and decreases in tension. This periodic increase and decrease in tension creates periodic forces upon the saddle 110 which then transfers these periodic forces to the soundboard 100 producing sound. These periodic forces may be described as a vector with a magnitude proportional to the tension in the string 108 and a direction determined by the string's 108 angle of bending over the top of the saddle 110. This vector may be broken into lateral 80 and vertical 81 force components. As the vertical force 81 increases the string rest 11 deforms and moves downward reducing the size of the notch 38. This in turn produces a force into the top of the transducer 21 which is rigidly coupled to the string rest 11. This vertical force 81 is thus sensed by the transducer 21. As the lateral force 80 increases, the saddle tries to rotate forward towards the neck 103 of the instrument. However, it is stopped by the wall of the bridge slot 109. In this way the bridge slot 109 resists the motion of the saddle 110 and creates a slot stress 82 on the front laminate 14 which is transferred to the transducer 21. In this way, the transducer senses the lateral force vector 80 from the periodic increase and decrease in tension of the vibrating string 108. This bidirectional sensing of the string energy reduces the effect of the shaping of the saddle 11 over the transducer providing a more consistent output between transducers in the saddle 110.

FIG. 8 depicts the back laminate 12, its associated rigidly and electrically connected components 32, 31, 33, and electrical traces 40. The flexible electrical conductors 31 and 33 are rigidly and electrically coupled to electrical pads on the back laminate 12 by solder or electrically conductive epoxy. These pads are connected to contacts within the connectors 32 by electrical traces 40 in the back laminate 12. In this way, the signals from the transducers 21 are conveyed through the connectors 32 to the removable cables 33a and 33b which are connected at their remote ends 33c and 33d to a preamp 90 (see FIG. 12). Removable cable 33a is shown removed from its associated connector 32, while removable cable 33b is shown connected to its associated connector 32.

In some embodiments of the invention, electrical components such as a resistor 99 which constitute a part of the remote preamp 90 (see FIG. 12) transducer signal receiving circuits may be contained within the saddle 110. This may be done to improve the electrical characteristics of the transducers 31 or for any number of reasons. Those skilled in the art will recognize that many types of electrical components may be employed for these purposes.

FIG. 9 depicts a front isometric view of the preferred embodiment of the invention and depicts the back laminate 12, its rigidly and electrically mounted components 32, 32, and 33, and the center laminate 13 shaped to form cavities 36 which allow space for the transducers 21 and flexible electrical conductors 31 and 33. The adhesive layer 35 exists everywhere the center laminate 13 abuts the back laminate 12.

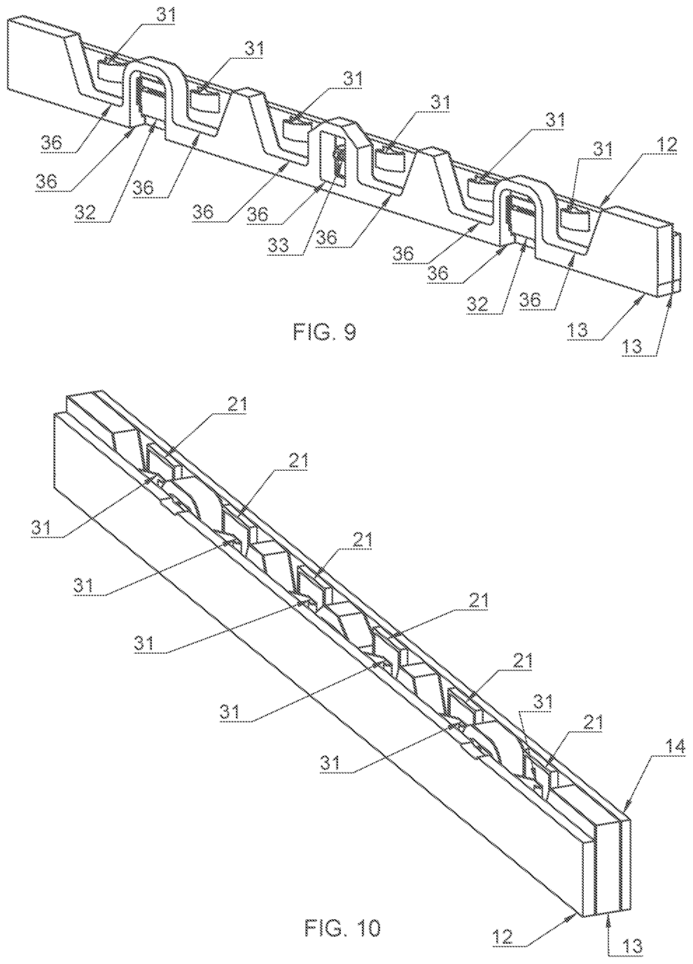

FIG. 10 depicts a rear isometric view of the laminate structure consisting of the front 14, inner 13, and back 12 laminates, along with their respective rigidly and electrically connected components (transducers 21 and flexible electrical contacts 31 shown). This figure clearly depicts the connection of each transducer 21 to its associated flexible electrical conductor 31.

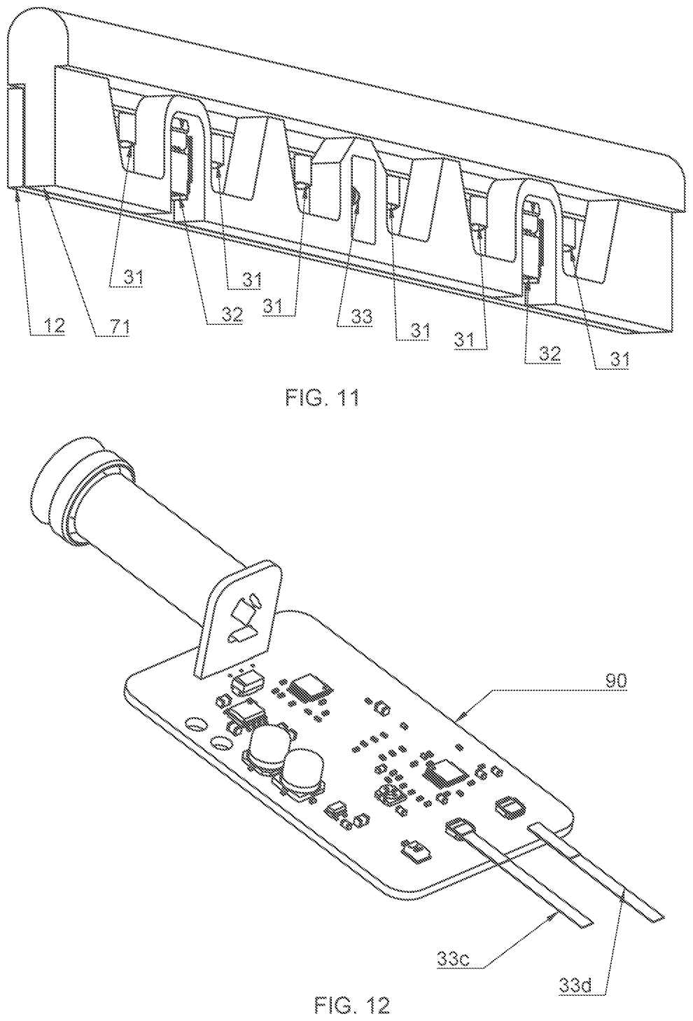

FIG. 11 depicts an alternate embodiment of the invention where the inner laminate 13 and string rest 11 are of a single piece 71 comprising a string rest that extends through the saddle 110. The front 14 and back 12 laminates may be attached to this string rest 71 with an adhesive such as glue, epoxy, heat film, or solder. This alternate embodiment is simpler to assemble. However, the string rest 71 is much more geometrically complex than either the inner laminate 13 or the string rest 11 of the preferred embodiment.

FIG. 12 depicts an instrument preamp 90 which receives the signals from the transducers 21 (see FIG. 4) through the removable multi-conductor cables 33c and 33d and amplifies, conditions, and combines these signals. This preamp 90 is typically located inside the body of the instrument, but it may be located in the instrument side 102 (see FIG. 1), or remote to the instrument.

While specific embodiments of the invention have been illustrated and described, such embodiments should be considered illustrative and not as limiting the invention as construed in accordance with the accompanying claims.

What is claimed is:

1. A stringed musical instrument saddle comprising:
a plurality of electrically independent transducers and any electrical circuit components used to filter or transmit the transducer signal;
with said transducers being located within the saddle so as to sense string vibrational energy in both vertical and horizontal directions;
Said saddle having at least one electrical connector which connects the independent transducer signals to at least one removable multi-conductor cable which transmits the signals externally;
Said saddle being constructed of workable materials which can be shaped on the top and bottom by a technician to fit a particular instrument.

2. The invention of claim 1 where the saddle is constructed of workable materials which can be shaped by a technician on all sides to fit a particular instrument.

3. The invention of claim 1 where said saddle is composed of top string rest, a front laminate structure, a back laminate structure, and at least at least one inner laminate structure.

4. The invention of claim 3 where one or more of the laminate structures contain at least one layer of copper so as to constitute a circuit board on which may be mounted mechanical and electrical components.

5. The invention of claim 1 where the number of transducers is equivalent to the number of courses on the instrument.

6. The invention of claim 1 where the number of transducers is unequal to the number of courses on the instrument.

7. The invention of claim 1 where electrical components of circuits receiving the transducer signals are physically distributed between the saddle and the preamp.

8. The invention of claim 4 where electrical shielding planes exist on the outside facing sides of the laminate structures.

9. The invention of claim 1 with said electrical connectors being accessible by a technician to facilitate easy connection or disconnection of a removable cable.

10. The invention of claim 3 where the laminate structures or string rest are rigidly adhered together.

11. The invention of claim 3 where the laminate structures or string rest are semi-rigidly adhered together.

12. The invention of claim 3 where the string rest and inner layer constitute a single mechanical piece.

13. The invention of claim 1 where the string rest has notches in alignment with the transducers which allow the string rest to flex under the tension of the string.
